(19) United States
(12) Patent Application Publication
(10) Pub. No.: US 2012/0164401 A1
(43) Pub. Date: Jun. 28, 2012

(54) FABRIC

(75) Inventors: Christian Vieth, Worth (DE); Reinhold Kossendey, Radevormwald (DE); Axel Konopik, Wuppertal (DE)

(73) Assignee: POLYESTER HIGH PERFORMANCE GMBH, OBERNBURG (DE)

(21) Appl. No.: 13/393,416

(22) PCT Filed: Aug. 25, 2010
(86) PCT No.: PCT/EP2010/062360

§ 371 Date: Feb. 29, 2012

(30) Foreign Application Priority Data
Aug. 31, 2009 (EP) 09169002.4

(51) Int. Cl. B32B 3/00; B29C 43/24; B32B 7/02; B32B 27/12; D04B 1/00

(52) U.S. Cl. 428/195.1; 442/286; 442/394; 442/304; 428/212; 156/164

(57) ABSTRACT

A fabric having a base layer of a textile made from yarns of a biodegradable polymer, and a visible layer having a biodegradable film that is placed on the base layer as a separate layer, the yarns of the textile being multifilament yarns with a strength of more than 40 cN/tex measured according to DIN EN ISO 2062.

### BACKGROUND

Fabrics made from biodegradable materials are generally known. For example, document EP 1 418 201 proposes a biodegradable synthetic composition which can be configured in the form of a fiber non-woven, a film, or a sheet.

A disadvantage in the known fabrics is, however, that the fabrics are formed as one piece over the entire extension and apparently have the same characteristics. For example, one biodegradable fabric according to the prior art has a uniform stability.

A monofilament yarn is known from document DE 43 20 041 that is used for producing textile woven fabrics. The monofilament yarn was thereby produced from a biodegradable polymer. A disadvantage of the monofilament yarn according to this document is, however, that the monofilament yarn is especially stiff and heavy due to its large diameter and that base material produced from the monofilament is insufficient for use as base material that is suited for flexible and light-weight objects.

### SUMMARY

It was therefore an object of the present invention to provide a fabric which has an especially low mass per unit area while simultaneously having high strength and is flexible enough to also be adaptable to objects.

The object is achieved by a fabric having a base layer of a textile made from yarns of a biodegradable polymer, and a visible layer having a biodegradable film that is placed on the base layer as a separate layer, the yarns of the textile being multifilament yarns with a strength of more than 40 cN/tex measured according to DIN EN ISO 2062.

### BRIEF DESCRIPTION OF THE DRAWINGS

Embodiments of the invention are described in more detail by means of the following figures.

FIG. 1 shows the strength of different yarns.

FIG. 2 shows the strength of different yarns depending on the tensile elongation.

FIG. 3 shows the shrinkage of different yarns depending on the temperature.

### DETAILED DESCRIPTION OF EMBODIMENTS

A high stability of the base layer while simultaneously using few threads per centimeter in the base layer can be advantageously achieved by the construction of the base layer using multifilament yarns having a strength of at least 40 cN/tex (measured according to DIN EN ISO 2062 or ASTM D 885 respectively). Due to the low number of threads per centimeter, the mass per unit area of the base layer can be advantageously reduced and simultaneously the production method can be simplified and accelerated. The use of multifilament yarns enables the production of a flexible base layer—thus adaptable to the object. Due to the multifilament yarns, the base layer can for example be more easily bent in order to apply or present the visible layer without breaking or damaging the base layer. By using monofilaments—which as a rule have a thick cross section—for the construction of the base layer, the ability of the base layer to bend, without damaging the base layer, is strongly reduced.

Due to the multi-layer construction of the inventive fabric, the fabric can furthermore be better adapted to the respective application of the fabric. For example, the textile of the base layer can be, according to the intended use, woven, knitted, or laid with varying tightness such that fabrics of varying stability can be created using the same film for the visible layer. Further, the visible layer can be provided with varying aesthetics, by which means different fabrics can be generated by using the same base layers but aesthetically different visible layers. This type of “modular design principle” is especially advantageous for reducing storage costs while simultaneously increasing variation possibilities with respect to the embodiment of the biodegradable fabric.

The base layer is preferably configured with sufficient stability that it can support the visible layer without for example folding over. In the case of a film as the visible layer, the base layer is for example so stable that, when there is a connection between the film and base layer, the fabric thus formed does not roll up by itself.

Preferably the base layer is formed as an industrial base layer. An industrial base layer consists predominantly and preferably completely of industrial yarns. In contrast to textile yarns, industrial yarns possess a greater strength. The strength of industrial yarns is greater than 40 cN/tex, measured according to DIN EN ISO 2062 (ASTM D 885).

The multifilament yarns of the base layer preferably have a strength of more than 45 cN/tex and particularly preferably of more than 50 cN/tex. It is further preferred that the multifilament yarn of the base layer is a 1100 dtex yarn with 210 filaments. The force at rupture is preferably 54.1 N and the breaking tenacity (also designated merely as strength) is preferably 47.5 cN/tex.

Further, the elongation at rupture is preferably 35% and the shrinkage is preferably 3.5%, measured for 2 minutes at 130° C. with a pre-tensioning of 1 mN/tex. The force at rupture, elongation at rupture, and breaking tenacity were measured according to DIN EN ISO 2062.

The multifilament yarn for producing the base layer is particularly preferably the yarn Diolen® 150 BT, 1100 dtex f210. The cited yarn consists of polylactic acid and is sold by Polyamid & Polyester High Performance. The base layer can likewise preferably consist of at least one yarn, the fibers thereof being preferably produced from the polymer 4032 D and/or 6400 D from NatureWorks LLC.

The visible layer is preferably the layer of the fabric, which layer is seen by, or should be seen by, an observer. For example, the printed surface of a poster is a visible layer. The visible layer consists preferably only of the aforementioned film, for which reason in the following the terms visible layer and film are used synonymously.

In a preferred embodiment, the base layer consists exclusively of the textile. The textile of the base layer can for example be a woven, a knit fabric (unidirectional or multidirectional), a composite, or a non-woven.

The base layer and/or the visible layer consists particularly preferably completely of biodegradable polymers, by which means the visible layer and/or the base layer is biodegradable.

A biodegradable visible layer and/or base layer should be understood as meaning that the visible layer and/or the base layer is produced substantially completely from biodegradable material. The visible layer and the base layer are substantially completely produced from biodegradable materials if the visible layer and/or the base layer comprises a portion of biodegradable material that is at least 70%, preferably at least 80%, particularly preferably at least 90%, and more particularly preferably 100%. A biodegradable material should be understood as any material that can be decomposed by microorganisms, enzymes, or hydrolysis according to the guidelines of DIN Standard 13432:2000-12 within approximately six to ten weeks in a large composting plant. Biodegradable materials are for example bioplastics made from renewable raw materials, additivated polyolefin films such as polyethylene, and petroleum based materials, such as for example Ecoflex from BASF.

The visible layer and/or the base layer is particularly preferably produced completely from PLA (polylactic acid) polymer 4032 D made by NatureWorks or polymer 6400 D made by NatureWorks or a mixture of the aforementioned polymers. Likewise, the base layer is particularly preferably produced by melting PLA polymer 6400 D pellets and spinning this melt into a yarn. The visible layer is more particularly preferably produced by melting PLA polymer 4032 D pellets and processing this melt into a film.

Because the fabric can be constructed from a biodegradable textile and a biodegradable visible layer, a biodegradable fabric is also reported in the following. It is thereby understood that the biodegradable fabric can also contain layers or materials that are not biodegradable according to the above mentioned definition. The base layer preferably has a textile made of yarns made from biodegradable polylactic acid. The base layer consists particularly preferably thereby completely of the textile, wherein the textile consists completely of yarns made from polylactic acid. The use of polylactic acid is especially advantageous because the production and processing of polylactic acid is already well researched and polylactic acid is a biologically degradable material.

As a textile for forming the base layer, for example, a knitted fabric, a non-woven, a woven, or a composite can be used. Wovens and composites are embodiments of a lattice structure and are also designated jointly as lattices.

Preferably a linen weave is used as the woven. The linen weave can preferably have 7 threads per cm in the warp direction and 7 threads/cm in the weft direction (717 warp/weft) with a mass per unit area of approximately 170 g/m². Preferably, multifilament yarns with a linear density of 1100 dtex and a strength of 475 mN/tex are used to produce the woven.

The knitted fabric can preferably have 7.1 threads/cm in the warp and weft directions (i.e., 18 threads/inch in warp/weft) with a mass per unit area of approximately 170 g/m². Preferably, multifilament yarns with a linear density of 1100 dtex and a strength of 475 mN/tex are used to produce the knitted fabric. Additionally, a binding yarn with a linear density of 80 dtex is used that has the same shrinkage characteristics as the yarn used for warp and weft.

The composite can preferably have 4.9 threads/cm with a mass per unit area of approximately 110 g/m². Multifilament yarns with a linear density of 1100 dtex and a strength of 475 mN/tex are likewise preferably used to produce the composite.

Additionally preferably, the film of the visible layer contains polylactic acid. The film can thereby be manufactured for example from polylactic acid granulate or powder into the film using thermal shaping. It is especially preferable here if the finished film consists completely of polylactic acid and/or a polyester made from succinic acid and 1,4 butanediol (an aliphatic, biodegradable polyester). The film has for example a thickness from 30 μm to 1 mm.

It should be clear that for manufacturing the biodegradable fabric the already finished film is laid as a visible layer on the already finished base layer. In order to clarify that individual layers are used to form the biodegradable fabric, the designation “separate film” or “separate visible layer” is also used.

Suitable films are manufactured by means of blown film extrusion or film blowing processes. Methods of this type are known to a person skilled in the art. In order to blow films, a ring nozzle is connected downstream at the end of the extruder. The plasticized plastic compound is pressed into a tube which is inflated using air to a diameter many times the original and is drawn upwards with increased speed. Not only the drawing in the longitudinal and transverse directions but also the time point of the cooling determine the film thickness. The tube is then wound up, either folded flat as a tubular film or cut laterally as a flat film. Starch-based films are manufactured in large amounts using film blowing extruders.

Preferably the separate film of the visible layer is applied to the base layer of the biodegradable fabric by laminating or calendering. The connection of the visible layer to the base layer takes place particularly preferably through thermal lamination. By this means, the visible layer and the base layer are melted with each other under pressure and heat, in that at least one of the two cited layers surface fuses and functions as an adhesive between the layers. Consequently no further adhesive is required when using thermal lamination. However, it is additionally conceivable that the visible layer and the base layer are connected to each other by a laminating process. During the laminating process, an additional adhesive is used, wherein the adhesive is heated in the laminating process and by this means becomes tacky (hot lamination) or is already tacky (cold lamination). In the case of hot lamination, the visible layer and/or the base layer preferably has an additional adhesive layer with adhesive, which adhesive layer is in contact with the visible layer and/or the base layer (prior to the lamination process).

In contrast, during calendering a melt is fed through a system comprising a plurality of heated steel rollers arranged in series. By this means, film thicknesses from 25-1000 μm are created.

Preferably, the film of the visible layer (thus the film) has a printable surface. The surface of the film can be specifically processed in order to better accept printing ink. For example, the film can have a special coating/finish such that the film is suitable for use in ink jet printers. In another example, the film can be roughened on one of the surfaces in order to enable further processing of the film by means of silk-screening or plotter printing.

It is conceivable that the film is already printed when it is laid on the base layer to form the biodegradable fabric, or the biodegradable fabric is only printed after it is manufactured. To protect the printing, a protective layer can be provided for example over the printing (and also under the printing), which protective layer protects the printing from damage—for example during the production of the connection between the visible layer and the base layer. A protective layer of this type can for example be removed from the film after the production of the connection between the visible layer and the base layer or after the ultimate application of the biodegradable fabric, or it can dissolve during the production of the connection itself—for example by melting or evaporation.

The base layer and the visible layer can be constructed from the same material and/or have the same melting point. During a thermal lamination, at a uniform heating of the visible layer and the base layer, the visible layer as well as the base layer would be surface fused in this case, by which means a connection between the aforementioned layers takes place from the melting of the visible layer and the base layer.

It is naturally also conceivable that only one of the layers is heated and surface fused in order to produce the connection between the layers.

Preferably the visible layer has a different melting point from the base layer. For example, the base layer can consist of a biodegradable polymer that has a higher melting point than the biodegradable polymer of the visible layer. By this means, the visible layer melts at temperatures at which the base layer does not yet melt. During a thermal lamination of a visible layer of this type and a base layer of this type, the visible layer would be laid on the base layer and both layers would be pressed together for a short period of time under pressure at a temperature above the melting point of the visible layer. Due to the selected temperature, the visible layer would only surface fuse (by selecting only a short time period for the heating), while the base layer does not melt or surface fuse. The melt produced from the visible layer serves as an adhesive between the visible layer and the base layer.

It is also conceivable that the base layer consists of a biodegradable polymer with a lower melting point than the visible layer. In this case, the base layer can be at least surface fused during the thermal lamination (while the visible layer does not melt), by which means the melt of the base layer serves as an adhesive for producing the connection between the visible layer and the base layer.

During lamination as well as during calendering, it is conceivable that only one of the layers (visible layer or base layer) is heated, while in contrast the other layer is not heated. For example, to produce the biodegradable fabric, the base layer can be laid on a heatable first press and the visible layer can be laid on a non-heatable or even coolable second press. The first and second presses are pressed together to produce the connection of the layers.

The connection between the visible layer and the base layer is, in all of the aforementioned methods for producing the connection, fixed, such that the visible layer and the base layer can no longer be separated from each other without exercising force (and destroying at least one of the layers).

A further embodiment of the invention is a method for producing the previously described biodegradable fabric, wherein the method comprises: producing a textile as a base material from yarns made from a biodegradable polymer; producing a visible layer from a biodegradable film; and connecting the formed visible layer to the formed base layer, wherein the base material is produced from yarns having a strength of 40 cN/tex measured according to DIN EN ISO 2062.

Preferably, to produce the biodegradable fabric, a textile as the base material is produced from yarns made of a biodegradable polymer in a first step. The yarn can be manufactured from polylactic acid in a one-step or in a two-step method.

A one-step production method for manufacturing the yarn can be described as follows:

During a one-step method, a yarn is preferably formed with a linear density of 1100 dtex and 210 filaments. The polylactic acid used (polymer 4032 D or 6400 D from NatureWorks) is melted at 210° C. and the yarn subsequently extruded is stretched at a ratio of 1:4.3. The winding speed of the yarn thus produced is 1618 meters per minute and the relaxation is 1:0.92. The yarn thus produced has a strength of 43.6 cN/tex and an elongation of 37.6%. The shrinkage (hot air shrinkage) is 19.2% at 150° C.

A two-step production method for manufacturing the yarn can be described as follows:

During a two-step method, a yarn is preferably formed with a linear density of 1100 dtex and 210 filaments. The polylactic acid used (polymer 4032 D or 6400 D from NatureWorks) is melted at 210° C. and the yarn subsequently extruded is stretched at a ratio of 1:4.2. The winding speed of the yarn thus produced is 800 meters per minute and the relaxation is 1:0.93. The yarn thus produced has a strength of 47.5 cN/tex and an elongation of 35%. The shrinkage (hot air shrinkage) is 15% at 150° C. At a stretching of 1:5.35 and a relaxation of 1:0.93, the yarn from the two-step production method has a strength of 52.3 cN/tex and an elongation of 33.1%. The shrinkage (hot air shrinkage) in this case is 4.6% at 150° C.

Further, in a second step, a visible layer is preferably produced from a biodegradable material in the form of a film. In a third step, the visible layer and the base layer are laid on top of each other and connected to each other. The already mentioned possibilities are valid for the embodiment of the textile of the base layer and the film of the visible layer.

The following biodegradable polymer films can be used for the visible layer:

Ecoflex (BASF, melting point 115° C., film thickness 50 μm to 100 μm)

PLA film (melting point 170° C.), for example PLA polymer 4032 D Bionolle; Showa Highpolymer (melting point 115° C.)

Mater-Bi (melting point 115° C.)

The connection of the visible layer and the base layer with each other preferably takes place via lamination or calendering of the layers (base layer and visible layer).

Preferably the base layer and/or the visible layer is heated to laminate or calender the layers. During a thermal lamination, it is thereby particularly preferred if one of the layers is at least partially surface fused, whereas the other layer does not melt.

In one embodiment, the visible layer is heated to produce the connection. Here as well (as described above) only the visible layer can be heated, or the visible layer and the base layer are heated, wherein only the visible layer surface fuses or an adhesive layer (of the visible layer) melts. In this embodiment, the base layer does not melt, that is, the base layer is also not surface fused. In another embodiment, only the base layer is heated or the base layer and the visible layer are heated, wherein only the base layer (or an adhesive layer of the base layer) melts or surface fuses. In still another embodiment, the visible layer as well as the base layer are heated by lamination or calendering such that the visible layer as well as the base layer at least partially surface fuse. The melt of the surface layer and the melt of the base layer thereby function as adhesive in the case of thermal lamination. In the case of lamination, the visible layer as well as the base layer can have an additional adhesive layer, which melts during the heating of the two layers without melting the layers themselves.

Preferably, the surface of the visible layer visible to an observer of the biodegradable fabric is treated after the connection to the base layer. It is, however, also conceivable that the visible layer is subjected to a treatment before it is connected to the base layer. A treatment of this type can for example be the printing of the visible surface of the visible layer, or the preparation for printing and subsequent printing of the visible layer, and/or the sealing of the visible surface of the visible layer.

The biodegradable fabric described in this application is preferably used as a base material for printing methods, for example, an inkjet printer. For example, the biodegradable fabric produced can be inserted in a printer device and printed by the same. Because the biodegradable fabric is in this case the base for the printing, a base material for the print process is also reported in this context.

It is preferred if the printing inks are likewise biodegradable. Biodegradable inks are for example inks that are obtained from minerals, plants, and/or animals, such as indigo, scarlet, or crimson.
The biodegradable fabric provided with a(n) (im)print can preferably be used as an advertising, informational, or decorative surface or object. For example, a printed, biodegradable fabric can be used as perimeter advertising in a stadium. It is further conceivable that the biodegradable fabric is used as a poster for billboards, advertising columns, or temporary barriers. However, printed napkins, table cloths, screens, or covers (tarpaulins or similar) can also be biodegradable fabrics in embodiments. The biodegradable fabric can be advantageously used everywhere that only a short-term use of the fabric is desired with the lowest possible disposal costs. In the case of perimeter advertising or a poster advertisement, the advertising message or the information is intended to be conveyed for only a short time period (for example up to the end of a playing season or until a concert is past). After this time period has passed, there is no more use for the fabric, for which reason an uncomplicated and environmentally friendly disposal is desirable. In the case of the inventive fabric, the fabric can be easily composted without problems, wherein the rotting of the biodegradable fabric takes place over only a few weeks. Expensive and cost-intensive disposal steps can be advantageously avoided.

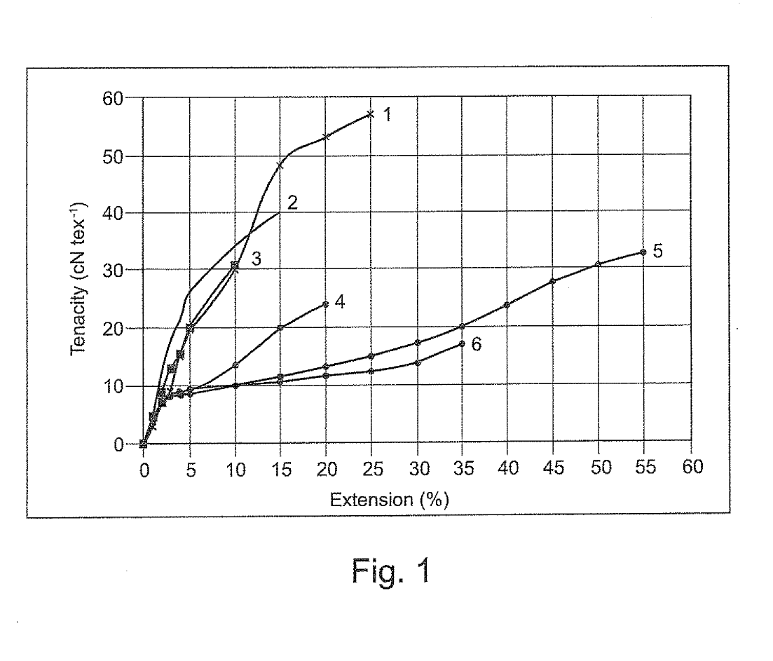

The strength of different yarns depending on the elongation is shown in FIG. 1. Reference number 1 designates the curve of an HT polyester yarn (HT=high tenacity). Reference number 2 designates the curve of a lyocell yarn, 3 describes the curve of a cotton yarn, 4 the curve of a viscose yarn, 5 the curve of a yarn made from polylactic acid, and 6 the curve of a wool yarn. All of the yarns shown in FIG. 1 are so-called textile yarns. Textile yarns differ from industrial yarns in that they have a lower strength and a higher elongation at rupture than the industrial yarns.

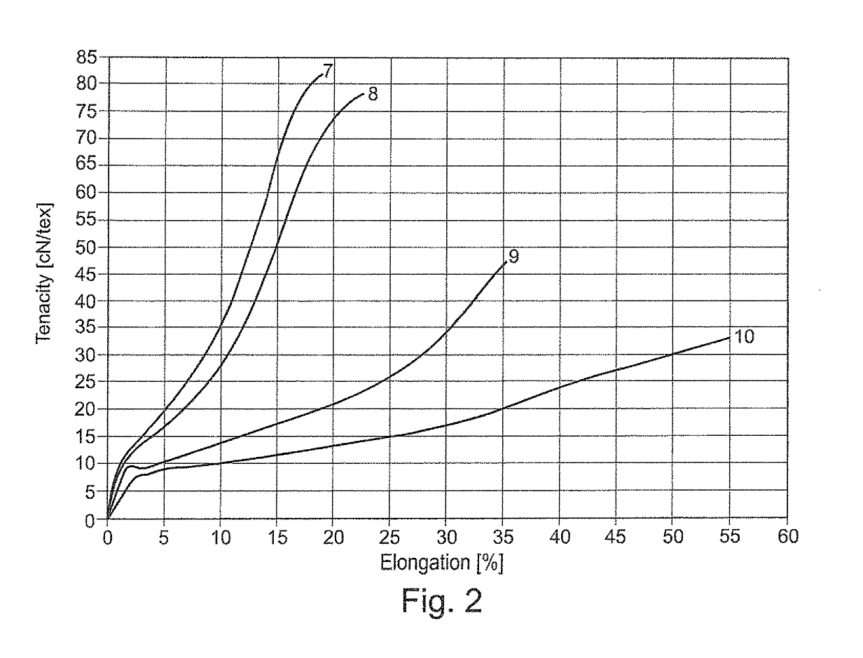

The elongation at rupture of industrial yarns in comparison to a non-industrial (thus a textile) polylactic acid yarn is shown in FIG. 2. The curve with reference number 7 is associated with a standard Diolen® yarn (polyethylene terephthalate, not a polylactic acid yarn) with the designation 174 ST and 1100 dtex at 210 filaments. The curve with reference number 8 is likewise associated with a standard Diolen® yarn (polyethylene terephthalate, not a polylactic acid yarn) with the designation 170 ST and 1100 dtex at 210 filaments. The curve of a yarn is designated with reference number 9 which is produced from polylactic acid and can be designated as an industrial yarn. This is the Diolen® 150 BT yarn with 1100 dtex at 210 filaments. In comparison to the curves for the aforementioned industrial yarns 7, 8, and 9, a textile yarn is also shown by curve 10. The textile yarn is a textile polylactic acid yarn.

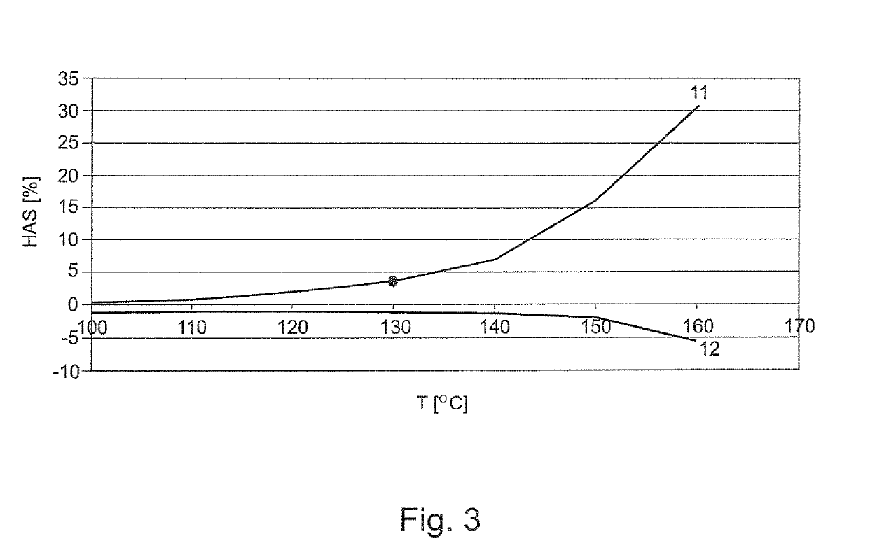

The shrinkage of the industrial polylactic acid yarn, Diolen® 150 BT with 1100 dtex, 210 filaments, is shown in FIG. 3. Curve 11 describes the shrinkage of a yarn at a pre-tensioning with 1 mN/tex, and curve 12 describes the shrinkage at a pre-tensioning with 5 mN/tex.

1. A fabric comprising:
a base layer comprising a textile made from yarns of a biodegradable polymer; and
a visible layer comprising a biodegradable film that is placed on the base layer as a separate layer,
wherein the yarns of the textile are multifilament yarns and have a strength of more than 40 cN/tex measured according to DIN EN ISO 2062.

2. The fabric according to claim 1, wherein the textile of the base layer comprises multifilament yarns made from biodegradable polylactic acid, the yarns having a strength of more than 40 cN/tex measured according to DIN EN ISO 2062.

3. The fabric according to claim 1, wherein the film of the visible layer comprises polylactic acid.

4. The fabric according to claim 1, wherein the textile of the base layer is a woven fabric, a knitted fabric, a composite fabric, or a non-woven fabric.

5. The fabric according to claim 1, wherein the film of the visible layer is laminated or calendered to the base layer.

6. The fabric according to claim 1, wherein the film of the visible layer has a printable surface or is printed.

7. The fabric according to claim 1, wherein the base layer has a higher or lower melting point than the visible layer.

8. A method for producing a fabric, comprising:
producing a textile as a base material from yarns made from a biodegradable polymer;
producing a visible layer from a biodegradable film; and
connecting the formed visible layer to the formed base layer,
wherein the base material is produced from yarns having a strength of 40 cN/tex measured according to DIN EN ISO 2062.

9. The method according to claim 8, wherein connecting of the base layer and the visible layer takes place by laminating or calendering.

10. The method according to claim 9, wherein the base layer is heated for the lamination or calendering.

11. The method according to claim 9, wherein the visible layer is heated for the laminating or calendering.

12. The method according to claim 9, wherein the visible layer as well as the base layer is heated for the laminating or calendering.

13. The method according to claim 8, further comprising treating a surface of the visible layer after or prior to the laminating or calendering.

14. A base material for a printing process comprising the biodegradable fabric according to claim 1.

15. An advertising, informational, or decorative surface or object comprising the biodegradable fabric according to claim 1.
